(19) United States
(12) Patent Application Publication
(10) Pub. No.: US 2006/0269679 A1
(43) Pub. Date: Nov. 30, 2006

(54) Polysaccharide based hydrophilic coatings

(75) Inventor: Damodar R. Patil, Peoria, IL (US)

Correspondence Address: CONLEY ROSE, P.C., P. O. BOX 3267, HOUSTON, TX, 77253-3267, US

(73) Assignee: Biotechnology Research and Development Corp., Peoria, IL (US)

(21) Appl. No.: 11/138,737

(22) Filed: May 26, 2005

(51) Int. Cl. C08B 30/12; B05D 1/02

(52) U.S. Cl. 427/421.1; 127/32

(57) ABSTRACT

A hydrophilic coating composition comprising a hydrophilic base material, an adhesion promoter and a surfactant. A method of applying a hydrophilic coating to a hydrophobic surface comprising preparing a hydrophilic coating, heating the hydrophilic coating and spraying the hydrophilic coating on the hydrophobic surface. A method of preparing a hydrophilic coating comprising preparing a solution of hydrophilic base material, heating the solution of hydrophilic base material and mixing at least a portion of the heated hydrophilic base material solution with an adhesion promoter and a surfactant.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates generally to adhesive coatings. More specifically, this invention relates to hydrophilic adhesive coatings for hydrophobic substrates.

### BACKGROUND OF THE INVENTION

Articles constructed from synthetic polymeric materials such as polyethylene (PE) and polypropylene (PP) have found widespread use in our daily lives. While such polymeric materials have desirable bulk mechanical properties they often exhibit undesirable surface properties. This may limit their utility since the surface properties of polymeric materials are often a major determinant in their usage. Thus, despite their widespread applications, a need exists to remedy certain limitations associated with the usage of synthetic polymeric materials. One method of increasing the adaptability of these polymeric materials to new uses has been to modify their surface properties. In particular, modifications of the surface of hydrophobic polymeric materials are often required to extend their utility. For example, medical devices constructed of hydrophobic polymeric materials may have their surface modified to enhance characteristics such as lubricity while reducing undesirable characteristics such as friction. Other polymeric constructs such as packaging containers may require modification of the hydrophobic polymeric surface to enhance printability thereby facilitating improved aesthetic quality for the consumer.

One approach to surface modification involves altering the hydrophobicity of the polymeric surface by applying a coating having the desired properties. Introduction of a hydrophilic coating to the hydrophobic surface of a polymer material would make these materials suitable for applications that require biocompatibility, compatibility with hydrophilic reagents, reduced electrostatic charge, reduced friction, improved barrier properties and improved absorption of water-based dyes and inks. However, due to their very different properties, the application of a hydrophilic coating to a hydrophobic substrate typically results in a surface coating with poor adhesion and durability. Furthermore, the currently known methodologies for introducing a hydrophilic coating to a hydrophobic surface typically require immersion of a hydrophobic surface into a solution containing the liquefied hydrophilic composition followed by drying. This methodology from a manufacturing standpoint is both time consuming and costly.

Given the foregoing problems it would be desirable to develop a hydrophilic coating for hydrophobic substrates that exhibits a high degree of adhesion. Furthermore, there also exists a need for an improved methodology for the application of a hydrophilic coating to a hydrophobic surface.

### BRIEF SUMMARY OF SOME OF THE PREFERRED EMBODIMENTS

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

In an embodiment, a hydrophilic coating composition is disclosed comprising a hydrophilic base material, an adhesion promoter and a surfactant.

In an embodiment, a method of applying a hydrophilic coating to a hydrophobic surface is disclosed comprising: preparing a hydrophilic coating, heating the hydrophilic coating and spraying the hydrophilic coating on the hydrophobic surface.

In an embodiment, a method of preparing a hydrophilic coating is disclosed comprising: preparing a solution of hydrophilic base material, heating the solution of hydrophilic base material and mixing at least a portion of the heated hydrophilic base material solution with an adhesion promoter and a surfactant.

### BRIEF DESCRIPTION OF THE DRAWINGS

For a detailed description of the preferred embodiments of the invention, reference will now be made to the accompanying drawings in which:

FIG. 1 is a schematic of a pneumatic coating sprayer.

FIG. 2 is a graph of coating adhesion for different hydrophilic coating formulations with 4% starch.

FIG. 3 is a graph of coating adhesion for different hydrophilic coating formulations with 6% starch.

FIG. 4A is a scanning electron micrograph of a substrate with a hydrophilic coating.

FIG. 4B is an annotated scanning electron micrograph of FIG. 4A.

### DETAILED DESCRIPTION OF THE PREFERRED EMBODIMENTS

In an embodiment, a hydrophilic coating (HC) comprises a hydrophilic base material, an adhesion promoter, and a surfactant. In an embodiment, the hydrophilic base material is a water-soluble polymer. Without limitation, examples of water-soluble polymers include natural gums such as karaya, tragacanth, ghatti and guar gum; polyvinyl alcohol; polyvinyl pyrrolidone; modified celluloses such as carboxymethyl, hydroxyethyl or hydroxypropyl cellulose; polyacrylic acid; polyethylenimne; or combinations thereof. Alternatively, the water-soluble polymer is a starch, modified starch or starch mixture.

In an embodiment, the starch may be a non-gelling starch, a waxy starch, an amylose-containing starch or combinations thereof. As used herein, a non-gelling starch is one that does not form a viscous semi-rigid structure upon absorption of water and heating or during the cooling of said solution. As used herein a waxy starch is one that contains less than about 10% amylose. As used herein an amylose-containing starch is one having equal to or greater than about 10% amylose. In an embodiment, the amylose content of the starch is less than about 13% w/v, alternatively less than about 12% w/v. Without wishing to be limited by theory, the reduced amylose content in the HC may prevent retrogradation and gel formation thereof.

In some embodiments, the starch is a gelling starch wherein gel formation can be reversed or inhibited. For example, the starch may be an amylose-containing starch containing about 25% amylose. Starch containing about 25% amylose when dissolved in water and heated forms a gel when the solution is allowed to cool to at room temperature. However, the gel formation may be reversed by agitating the solution, for example by stirring or shaking. Alternatively, gel formation in a 25% amylose containing starch solution may be inhibited by rapidly cooling the solution. Methods of rapidly cooling a solution are known to one skilled in the art and include transfer of the hot solution to an ice bath.

Starches suitable for use in the HC include without limitation those isolated from cereal crops such as rice and corn or tuber crops such as cassava and potato. Without limitation, examples of suitable starches include Starch from Rice (S7260), Starch from Corn (S9679) available from Sigma, Aldrich and Pure Food Grade starch and 7350 Waxy starch #1 from A. E. Staley. In an embodiment the HC comprises from about 2% to about 8% weight/volume (w/v) starch, alternatively from about 4% to about 6% w/v starch. The w/v is defined as the number of grams of a component in a solution divided by the total volume in milliliters of the solution multiplied by 100%. The term aqueous solution herein also refers to aqueous dispersions, in which solid materials are intimately dispersed in water so that they do not readily settle or otherwise separate from the aqueous phase. In an embodiment, aqueous solutions of each reagent in the HC are prepared by dissolving the reagent in a suitable volume of water. The concentration of the reagents at this point is termed the initial % w/v. The initial % w/v is calculated by dividing the grams of reagent used by the volume in milliliters of water added to produce the aqueous solution. In an embodiment, these aqueous solutions of reagents are used to prepare the HC. For convenience, the HC formulations are based on 100 grams of HC, with a resultant calculation of the grams of aqueous reagent required to prepare the 100 grams of HC. Upon addition of each of the reagents to the HC, the concentration of the reagent is diluted from the initial % w/v to a final % w/v. The final % w/v of each reagent in the HC is determined by multiplying the initial % w/v of each component by the number of grams of component used in preparing the 100 grams of the HC. The sum of the % w/v contribution of each component in the HC is referred to herein as the total solids content. Hereafter, the numerical values given with percentages refer to the final % w/v unless noted otherwise.

In an embodiment, the starch is provided as an aqueous starch solution. This aqueous starch solution may contain a sufficient amount of starch and water to produce an HC with a viscosity suitable for ease of pouring and/or sprayability. In an embodiment, the starch slurry may comprise an initial % w/v of from about 10% w/v to about 20% w/v starch in aqueous solution having a pH of from about 5.0 to about 7, alternatively about 7.

In some embodiments, the water-soluble polymer may be substituted with a water-dispersible or water-reducible polymer to provide a final formulation that is less hydrophilic in nature than the HC formed with a water-soluble polymer. Examples of water-dispersible and water-reducible polymers are known to one skilled in the art. HCs formed using water-dispersible or water-reducible polymers as the hydrophilic base material may result in coatings that are less hydrophilic than those formulated using water-soluble polymers as the hydrophilic base material. However, when compared with the surface of a suitable hydrophobic polymeric substrate the HCs prepared with water-reducible or water-dispersible polymers may be more hydrophilic than the substrate surface. Thus, application of an HC having a water-dispersible polymer or water-reducible polymer as the hydrophilic base material may provide a coating that enhances desirable surface properties of the substrate to which it is applied. However, for simplicity herein the term HC refers collectively to coatings prepared with water-dispersible, water-reducible or water-soluble polymers.

In an embodiment, the HC comprises an adhesion promoter. Without wishing to be limited by theory, the adhesion promoter may serve to increase the compatibility between the HC and the hydrophobic substrate through the reduction of interfacial tension. Interfacial tension is defined as the surface free energy that exists between two immiscible liquid phases, such as oil and water. In an embodiment, the adhesion promoter is any material chemically compatible with the HC that serves to increase the adherence of the HC to the hydrophobic substrate by reducing the interfacial tension. In an embodiment, the adhesion promoter is an epoxy resin present in amounts of from about 0.5% to about 2.0% of the HC.

Without limitation, examples of suitable adhesion promoters include EPI-REZ Resin 3510-W-60 available from Resolution Performance Products and Epoxy 6128W65 from Pacific Epoxy Polymers. In an embodiment, an adhesion promoter for use in the HC (e.g., EPI-REZ Resin 3510-W-60) has about the physical properties given in Table I.

TABLE I

| Physical Property | Value |
|---|---|
| Viscosity at 25° C. | 500-5000 |
| (Brookfield RVT, #5 spindle at 10 rpm) | |
| Nonvolatiles, percent | 60-62 |
| Solvent | Water |
| Pounds/gallon | 9.0 |
| Particle size, Coulter (vol. mean), microns | 1.0-2.2 |
| pH | 2-5 |
| Weight per epoxide, on solids | 185-215 |

In an embodiment, the HC comprises a surfactant. Without wishing to be limited by theory, a surfactant in the HC may serve to modify physical properties thereof such as the surface tension, emulsification or cloud point. The surface tension is defined as the free energy between a liquid and air. In an embodiment, the surfactant is any material chemically compatible with the HC that is capable of reducing the surface tension of the HC while increasing adhesion of the HC to the substrate. In an embodiment, the surfactant is a fluorosurfactant. In an alternative embodiment, the surfactant is sodium lauryl sulfate. In an embodiment the HC comprises from about 0.05% to about 0.5% of surfactant, alternatively from about 0.1% to 0.3% of surfactant, alternatively about 0.25% surfactant. Without limitation, examples of suitable surfactants include Zonyl FSA and Zonyl FSP available from Dupont and sodium lauryl sulfate available from Sigma-Aldrich. In an embodiment, a surfactant for use in the HC (e.g., Zonyl FSP) has about the physical properties given in Table II.

TABLE II

| Property | Value |
|---|---|
| Structure | (R_{f}CH₂CH₂O)xP(O)(ONH₄)y |
| | where R_{f} = F(CF₂CF₂)z |
| | x = 1 or 2 |
| | y = 2 or 1 |
| | x + y = 3 |
| | z = 1 to about 7 |
| Solubility | 2% in water and methyl alcohol |
| | 0.7% in isopropyl alcohol |
| | 0.1% in acetone |
| | insoluble in ethyl acetate, THC, |
| | n-heptane, methyl chloroform |
| | and toluene |
| Specific gravity @ 25° C. | 1.15 |
| Density @ 25° C. (lb/gal) | 9.6 |
| Surface tension in deionized | 24 @ 0.01% active ingredient |
| water @ 25° C. (dyn/cm) | |

The HC may further comprise an effective amount of additives for improving or changing the properties thereof, including without limitation emulsifiers, plasticizers or combinations thereof. In an embodiment, the HC contains a plasticizer, which may serve to increase the flexibility, durability and shelf life thereof. Alternatively, the HC contains an emulsifier that may prevent separation of the formulation components. Suitable plasticizers and emulsifiers are known to one of ordinary skill in the art. In an embodiment, the HC may contain a single compound that functions as both a plasticizer and an emulsifier. Without limitation, an example of a plasticizer that also functions as an emulsifier for use in the HC is a nonionic/anionic wax emulsion such as Aquabead 270E available from MicroPowders Inc.

Other additives chemically compatible with the formulation may be introduced by one skilled in the art to vary the properties of the HC as needed. By way of example, the HC may be varied to contain antimicrobial agents or dyes if necessary to impart certain physical properties to the hydrophobic substrate.

In an embodiment, the HC may comprise from about 4 to about 6% hydrophilic base material, from about 0.5 to about 2% adhesion promoter, from about 0.1 to about 0.25% surfactant and optionally an effective amount of any additional additives with the remainder of the HC being an aqueous carrier fluid, such as water. In an embodiment, the HC may have a total solids content from about 6.0 to about 10%. In an embodiment the HC has a viscosity from about 80 centipoise to about 300 centipoise (cp), alternatively from about 100 cp to about 250 cp, alternatively less than about 200 cp. In an embodiment, the HC has an adhesion of almost 5A as determined in accordance with ASTM D 3359-02, the tape test method.

In an embodiment, for preparation of the HC, the hydrophilic base material is heated prior to the addition of other reagents. In an embodiment, the hydrophilic base material is a starch that is provided as a starch slurry. The starch slurry may be heated by any method suitable for heating and maintaining the temperature of the starch slurry. Without wishing to be limited by theory, heating the starch slurry may make the starch completely water-soluble by disrupting the granules and breaking the hydrogen bonding. The starch slurry may be heated by the process of jet-cooking. Herein the process of “jet cooking” refers to using a heat transfer device to instantaneously heat a flowing liquid with a hot condensable vapor and hold the heated liquid at a prescribed temperature for a prescribed time. Processes for jet cooking a starch slurry have been disclosed in U.S. Pat. Nos. 3,988,483, 4,232,046 and 6,709,763, each of which are incorporated by reference herein in their entirety. Examples of heat transfer devices suitable for use in jet cooking an aqueous starch slurry are the HYDROHEATER available from Attec and the AWEC 2400 mixing jet cooker available from Q-Jet and Penick and Ford Laboratory Model Steam Jet cooker.

Suitable conditions for jet cooking a starch slurry are known to one skilled in the art. The starch slurry may be jet cooked at a temperature from about 130° C. to about 150° C. and a pressure from about 20 psig to about 50 psig with a pumping rate of from about 0.75 to about 2.0 liters per minute. In an embodiment, the jet-cooked aqueous starch slurry is allowed to cool to room temperature. After treating the hydrophilic base material (e.g., starch slurry) as described, an appropriate amount of heated hydrophilic base material, adhesion promoter, surfactant, additives and water may be mixed together to prepare the HC. In some embodiments, the HC may be transferred to a device for application of the coating to a substrate. Alternatively, a single device may be used to prepare the HC and coat the substrate. The HC may be sprayed onto a hydrophobic surface. Sprayers suitable for use in this application are known to one skilled in the art and include pneumatic sprayers or spray guns. Examples of suitable pneumatic sprayers include without limitation, the EGA Manual Touch-Up Gun available from DeVilbiss Corporation or the AJ-401-LH sprayer commercially available from Jacto.

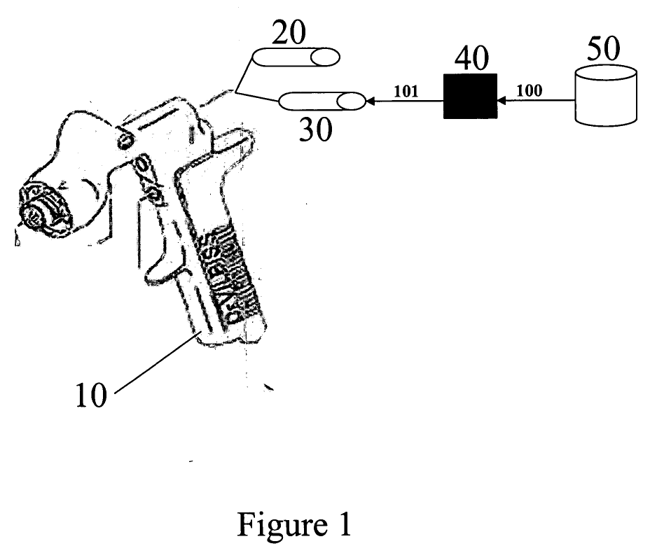

An embodiment of an apparatus for coating the hydrophobic substrate with the HC is depicted in FIG. 1. Referring to FIG. 1, a pneumatic sprayer 10 is coupled to container 20, reservoir 30, peristaltic pump 40 and solution container 50. Container 20 may contain a compressed gas such as air that is used to atomize the HC. In an embodiment, the HC is conveyed to reservoir 30 from solution container 50 by peristaltic pump 40 through lines 100 and 101. In an alternative embodiment, (not depicted), pneumatic sprayer 10 is fed by a local reservoir 30 coupled directly to the sprayer. In another alternative embodiment, (not depicted), the pneumatic sprayer 10 is directly coupled to line 101 and the contents of solution container 50 are fed directly to pneumatic sprayer 10 by peristaltic pump 40 through lines 100 and 101. Alternatively, any device suitable for storing and/or transferring the HC to the pneumatic sprayer 10 may be employed. Alternatively, the HC may be manually transferred to the pneumatic sprayer 10.

In an embodiment, the HC, the apparatus for coating the hydrophobic substrate, the hydrophobic substrate itself or combinations thereof may be heated prior to and/or during application of the HC to the substrate. For example, the pneumatic sprayer 10 may be used to apply the HC to a hydrophobic substrate in the presence of “hot air”. Herein hot air is defined as having an ambient temperature of greater than about 25° C. to less than about 60° C. The temperature of the air can be elevated through the use of a heating device such as a hot gun, heater, blower or other known device suitable for elevating the ambient air temperature. In an embodiment, the heating device is a hair dryer that may be set on the highest setting. The stream of atomized HC released from the pneumatic sprayer may be heated prior to contacting the substrate by a heating device integrated or in league with the spray device. Alternatively, a heating device external to the spray device may heat the stream of atomized HC. For example, an operator may simultaneously apply an HC to a substrate while directing a stream of hot air towards the HC as it is released from the pneumatic sprayer. Without wishing to be limited by theory, the use of a pneumatic sprayer may allow for the formation of droplets of HC of sufficient size that heating air causes evaporation of a substantial portion of the aqueous carrier fluid prior to the HC contacting a substrate. In another alternative embodiment, the HC may be heated as it is being transferred from a reservoir to the spray device.

The sprayed HC may form a coating that dries about instantaneously upon contacting the substrate; alternatively the sprayed HC may form a coating that dries in less than about 30 seconds from the time the coating contacts the substrate. In some embodiments, a drying device may be used to facilitate drying of the HC coating on the substrate. Suitable drying devices are known to one skilled in the art.

Upon contacting the substrate and drying, the HC may form a monolayer adhesive coating on the substrate. Alternatively, the substrate may be coated repeatedly with the HC to form a multilayer adhesive coating comprising from about 1 to about 24 layers. Hereafter, the term starch adhesive coating (SAC) refers to the HC formed when the hydrophilic base material is a starch and the HC has been applied to a substrate in one or more layers.

The HC may be used to coat a suitable substrate thus providing a hydrophilic layer to a surface. Suitable substrates for the HC include but are not limited to hydrophobic surfaces, alternatively polymeric surfaces, alternatively polyolefin surfaces. The substrate may comprise a homopolymer, copolymer, or blends thereof. Examples of suitable material surfaces that may serve as substrates for the HC include without limitation polyethylene terepthalate; polyethylenes such as high-density polyethylene, low-density polyethylene, linear low-density polyethylene; polypropylene; polyvinyl chloride; polystyrene and combinations thereof.

Polymer resins having the previously described properties may be formed into articles of manufacture or end use articles using techniques known in the art such as extrusion, blow molding, injection molding, fiber spinning, thermoforming, and casting. For example, a polymer resin may be extruded into a sheet, which is then thermoformed into an end use article such as a container, a cup, a tray, a pallet, a toy, or a component of another product. Examples of other end use articles into which the polymer resins may be formed include pipes, films, bottles, fibers, and so forth. In an embodiment, the substrate is an article of packaging of a consumer product. Additional end use articles would be apparent to those skilled in the art. The surface of such articles may serve as substrates for the HC.

In an embodiment, the HC produces a SAC capable of adhering to a hydrophobic substrate with a strength of from about 3 to about 5, alternatively from about 4 to about 5 as determined in accordance with ASTM D 3359-02, the standard method for measuring adhesion by tape test. The SAC may form a uniform hydrophilic coating on the substrate surface with a monolayer thickness of less than about 2 to less than about 5 microns

A SAC formed by the methodology disclosed herein may have starch absorbed from about 0.01 to 0.2 mg per square cm of substrate, alternatively from about 0.035 to about 0.15 mg per square cm of substrate. A SAC of this disclosure may have an opaque(turbid) appearance.

Scanning electron microscopy may be used to characterize the morphology and interfacial microstructure of the SAC. SACs of this disclosure display a uniform coating with the appearance of some micropores and cracking that may not affect the adhesion of the coatings.

Substrates having HCs of this disclosure may display desirable surface properties such as biocompatibility, compatibility with hydrophilic reagents, reduced electrostatic charge, reduced friction and improved barrier properties. In an embodiment, the hydrophobic substrate having an HC may then display improved absorption of water-based dyes and inks. In one embodiment, an article surface having an HC may be further processed for example, by the application of an image or colorant directly to the article.

### EXAMPLES

The invention having been generally described, the following examples are given as particular embodiments of the invention and to demonstrate the practice and advantages thereof. It is to be understood that the examples are given by way of illustration and are not intended to limit the specification of the claims in any manner.

### Example 1

Starch slurries were prepared by jet cooking 700 g of waxy corn starch in 3500 ml of water at 140° C. and 40 psig at a rate of 1 liter/minute in a Penick and Ford Laboratory Model Steam Jet Cooker. Referring to Table III, an HC was prepared by mixing the indicated amounts of reagents. The final starch concentration was 6% w/v. All percentages in the examples are of final w/v unless otherwise indicated.

The HC was stirred for 30 minutes and the viscosity of the HC measured by a Brookfield Viscometer Model LV at 60 RPM. The HC was fed to a pneumatic sprayer (EGA Manual Touch-Up Gun), which was used to coat a plastic surface. During application of the coating, a hot air gun set on the highest setting was aimed at the pneumatic sprayer. The HC dried upon contacting the plastic surface.

TABLE III
Formulation for Starch Adhesive coating

| Reagent* | Grams | % w/v** |
|---|---|---|
| JCW Starch (13.1%) | 45.8 | 6.0 |
| Aquabead 270E (40%) | 3.0 | 1.2 |
| EPI-REZ Resin 3510-W-60 | 3.2 | 2.0 |
| (62%) | | |
| Zonyl FSA (25%) | 1.0 | 0.25 |
| Water | 47 | balance |

*In parentheses is given the initial w/v of each reagent.
**% w/v refers to the final % w/v in the HC.

The above HC had a total solids content of 9.45% and showed no settling of particles after being kept for 72 hours at 25° C. The total solids content was varied by adjusting the amount of starch slurry in the HC from 4 to 6%. The extent of adhesion for three HCs with the indicated total solids content were determined in accordance with ASTM D3359-02, (the tape test method) and are given in Table IV.

TABLE IV
Effect of Total Solids Content on Adhesion

| Total Solids Content | Viscosity, cps | Adhesion |
|---|---|---|
| 9.45 | 140 | Almost 5A |
| 8.0 | 90 | Almost 5A |
| 6.0 | 55 | Almost 5A |

The results demonstrate that HCs having a total solids content in the range of 6.0% to 9.45% produced SACs with an adhesion of almost 5A. However, HCs containing greater than 6% starch concentration were highly viscous and formed coatings with reduced adhesion. Furthermore, HCs with less than 4% starch concentration were too dilute for coating applications.

### Example 2

Starch slurries were prepared, viscosity measured and the formulations applied to a substrate as described in Example 1. The formulation was used to coat a 6″×6″ polyethylene surface with up to 24 layers and the adhesion of the coating determined in accordance with ASTM D 3359-02. Referring to Table V, an HC was prepared by mixing the indicated amounts of reagents. In the presence of all of the indicated reagents, 6.0% starch, 2.0% EPI-REZ Resin 3510-W-60, 1.2% Aquabead 270E and 0.25% Zonyl FSA, the formulation has an adhesion of almost 5A. Table V presents the adhesion values in the absence of the indicated reagent with all other reagents remaining the same.

TABLE V

| | | Adhesion in |
|---|---|---|
| | | the absence of |
| Reagent/(Original concentration w/v)* | % w/v** | the reagent |
| JCW Starch (13.1%) | 6.0 | 0 |
| EPI-REZ Resin 3510-W-60 (62%) | 2.0 | 0 |
| Zonyl FSA (25%) | 0.25 | 2A |

*In parentheses is given the initial w/v of each reagent.
**% w/v refers to the final % w/v in the HC.

These results demonstrate the relative contribution of each component of the HC to the adhesive properties of the coating.

### Example 3

Starch slurries were prepared, viscosity measured and the formulations applied to the substrate as described in Example 1. In the presence of 6.0% starch, 2.0% EPI-REZ Resin 3510-W-60, 1.2% Aquabead 270E and 0.25% Zonyl FSA, the formulation has an adhesion of almost 5A. Reagents in the formulation were substituted as indicated in Table VI with the remainder of the formulation staying the same. The formulation was used to coat a polyethylene surface and the adhesion of the coating determined in accordance with ASTM D 3359-02

TABLE VI
Effect of Alternative Reagents on Adhesion

| | | |
|---|---|---|
| For | Replaced with | Adhesion |

Plasticizers

| | | |
|---|---|---|
| Aquabead 270E | No plasticizer | Almost 5A |
| | Glycerol | Almost 5A |
| | Propylene glycol | Almost 5A |

Adhesion Promoters

| EPI-REZ Resin | Epirez 3515-w-60 | | 4A |
|---|---|---|---|
| 3510-W-60 | | | |
| | Ancarez AR 550 | | 2A |
| | Rovene | 4009 | 2A |
| | | 4019 | 2A |

| | |
|---|---|
| Macecote 149-43-1 | 1A-2A |
| Doresco ACW 8-6 | 2A |
| Surelease E-7-19010 | 2A |
| Jonacryl 1987 | 1A |
| PVA-405 | 1A |
| PVP K-30 | 1A |
| Lupasol PS | 0A |
| Airflex 4530 | 1A |
| Flexbond 825 | 2A |
| Airflex 465 | 1A |
| Silres MP 42E-A | 1A |
| Poly(ethylene oxide) Mw 100,000 | 0A |
| Poly(acrylic acid) Mw 50,000 | 0A |
| Epoxy 6128w65 | 4A |

Surfactant

| | | |
|---|---|---|
| Zonyl FSA | Lumisorb psmo20 | 2A |
| | Triton X-305 | 0A |
| | Zonyl FSJ | 4A |
| | Zonyl FSO | 3A |
| | Zonyl FSN | 3A |
| | Zonyl FSP | Almost 5A |
| | Dowfax 2A1 | 0A |
| | Sodium Octyl Sulfate | 2A |
| | Sodium Lauryl Sulfate | 4A |
| | Silwet L-7607 | 1A |
| | CoaOsil 1211 | 0A |
| | Surfynol 485W | 2A |
| | Rhodapac RM 510 | 0A |
| | Alcodet 218 | 1A |
| | Miranate B | 0A |

These results demonstrate that starch coatings displaying adhesion in the range of 4A to 5A can be prepared using a suitable combination of starch, adhesion promoter and surfactant. The addition of a plasticizer or emulsifier has no effect on the adhesion but imparts other desirable properties to the formulation such as increased shelf life and preventing the separation of formulation components.

### Example 4

Starch slurries were prepared by jet cooking 750 g of starch in 3500 ml of water at 140° C. and at 40 psig at a rate of 1 liter/minute in a Penick and Ford Laboratory Model Steam Jet Cooker. The amylose content for each of the starches used is given in Table VII. An HC was prepared by adding either 0.8 or 1.2% Aquabead 270E as indicated, 0.25% Zonyl FSA, water and the indicated amounts of starch slurry and EPI-REZ Resin 3510-W-60. Starch slurries containing a gelling starch were also prepared. For the gelling starch, slurries were prepared by jet cooking 150 g of starch (25% amylose) in 100 ml of water at 140° C. and at 40 psig at a rate of 1 liter/minute in a Penick and Ford Laboratory Model Steam Jet Cooker. This suspension was divided into two fractions: one fraction was cooled at ambient temperature (1^{st} Fraction) and second fraction was cooled in ice (2^{nd} Fraction). The fraction cooled at room temperature formed gel that could be re-dispersed by stirring or shaking. The fraction cooled in ice stayed in fluid form without forming a gel. An HC was prepared by adding 0.8% Aquabead 270E as indicated, 0.25% Zonyl FSA, water and the indicated amounts of starch slurry containing the 25% amylose containing starch and EPI-REZ Resin 3510-W-60. This formulation is denoted in Table VII as 25% amylose cooked once.

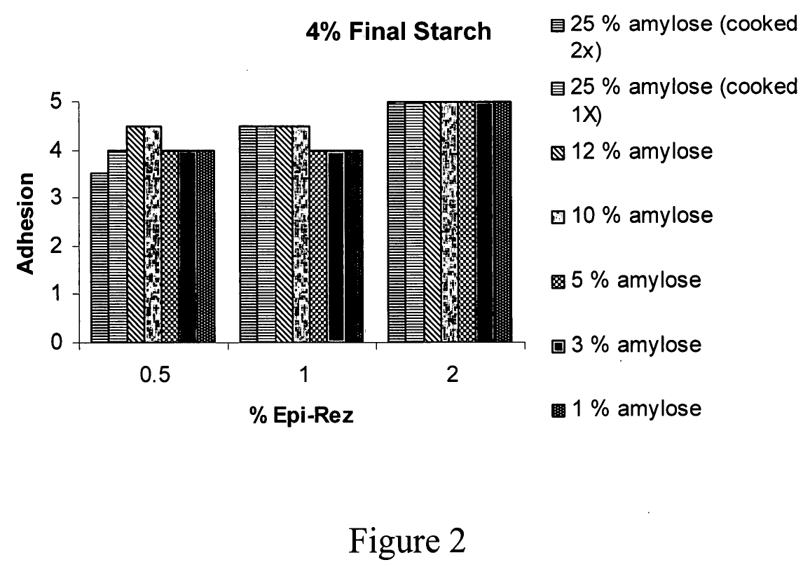

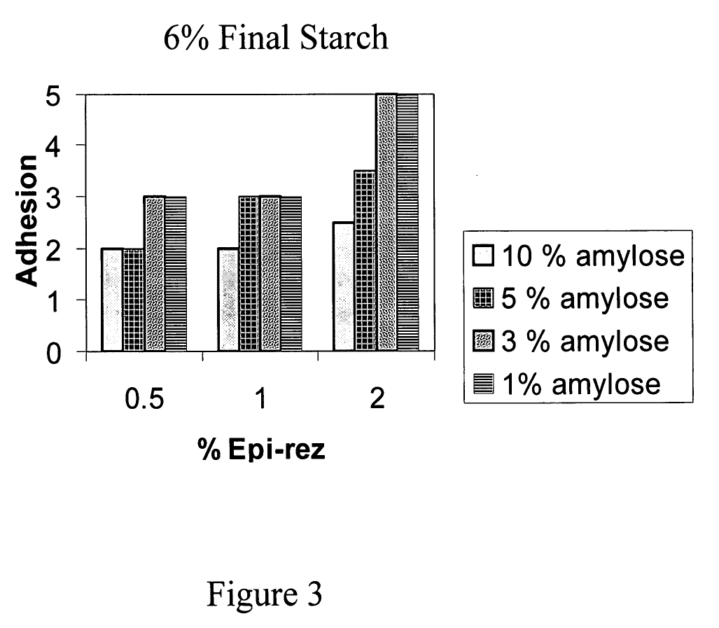

A second formulation was also prepared having the gelling 25% amylose containing starch as the hydrophilic base material. In this preparation, after the first pass through the jet cooker, the resulting dispersion was cooked a second time under the same conditions. This suspension was divided into two fractions: one fraction was cooled at ambient temperature (1^{st} Fraction) and second fraction was cooled in ice (2^{nd} Fraction). The fraction cooled at room temperature formed gel that could be re-dispersed by stirring or shaking. The fraction cooled in ice stayed in fluid form without forming a gel. This formulation is denoted in Table VII as 25% amylose cooked twice. For all formulations, HC was stirred for 30 minutes and the viscosity of the HC measured by a Brookfield Viscometer Model LV at 60 RPM. A sample was then fed to a pneumatic sprayer, the EGA Manual Touch-Up Gun. The formulation was used to coat a polyethylene surface and the adhesion of the coating determined in accordance with ASTM D 3359-02. FIGS. 2 and 3 show graphs of the adhesion of the starch coating to a polyethylene substrate as a function of the concentration of EPI-REZ Resin 3510-W-60, the final concentration of starch and the amylose content of the starch. Table VII lists the viscosities of the formulations. Final starch concentrations were either 4 or 6% for FIGS. 2 and 3 respectively. In the case of the 25% amylose containing starch, formulations having a final concentration of 6% starch were too viscous to spray and thus values for the adhesive coatings were not determined.

TABLE VII
Viscosity of HC solutions in cp*

| | EPI-REZ Resin 3510-W-60 | | |
|---|---|---|---|
| | concentration (w/v) | | |
| % amylose | 0.5 | 1.0 | 2.0 |
| 25 (4% final starch) | 180 | 190 | 195 |
| cooked once 1^{st} fraction | | | |
| (Cooled at RT) | | | |
| 25 (6% final starch) | 1320 | ND | ND |
| cooked once 1^{st} fraction | | | |
| (Cooled at RT) | | | |
| 25 (4% final starch) | 160 | 160 | 160 |
| cooked once 2^{nd} fraction | | | |
| (Cooled in ice) | | | |
| 25 (6% final starch) | 760 | ND | ND |
| cooked once 2^{nd} fraction | | | |
| (Cooled in ice) | | | |
| 25 (4% final starch) | 150 | 150 | 150 |
| cooked twice 1^{st} fraction | | | |
| (cooled at RT) | | | |
| 25 (6% final starch) | 600 | ND | ND |
| cooked twice 1^{st} fraction | | | |
| (cooled at RT) | | | |
| 25 (4% final starch) | 75 | 75 | 75 |
| cooked twice 2^{nd} fraction | | | |
| (cooled on ice) | | | |
| 25 (6% final starch) | 400 | ND | ND |
| cooked twice 2^{nd} fraction | | | |
| (cooled on ice) | | | |
| 12 (4% final starch) | 125 | 130 | 135 |
| 12 (6% final starch) | 450-500 | ND | ND |
| 10 (4% final starch) | 100 | 105 | 110 |
| 10 (6% final starch) | 320 | 325 | ND |
| 5 (4% final starch) | 85 | 90 | 95 |
| 5 (6% final starch) | 220 | 230 | 235 |
| 3 (4% final starch) | 80 | 85 | 95 |
| 3 (6% final starch) | 200 | 205 | 210 |
| 1 (4% final starch) | 70 | 75 | 85 |
| 1 (6% final starch) | 180 | 185 | 190 |

*cp = centipoise

The result is that the highest levels of adhesion were achieved with final starch concentrations of 4% that maintained a viscosity below 200 cp because of the smaller droplet size due to the decrease in viscosity.

### Example 5

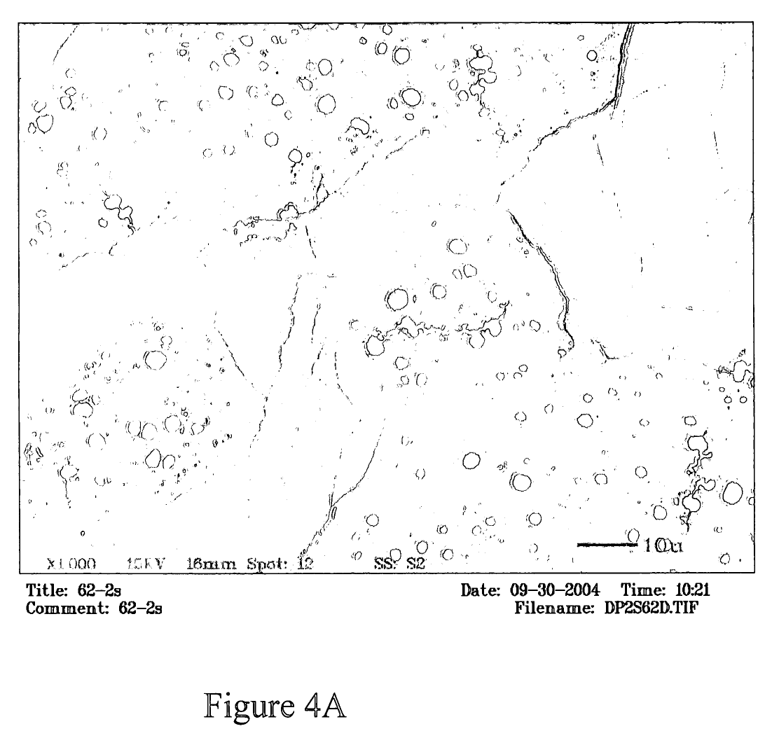

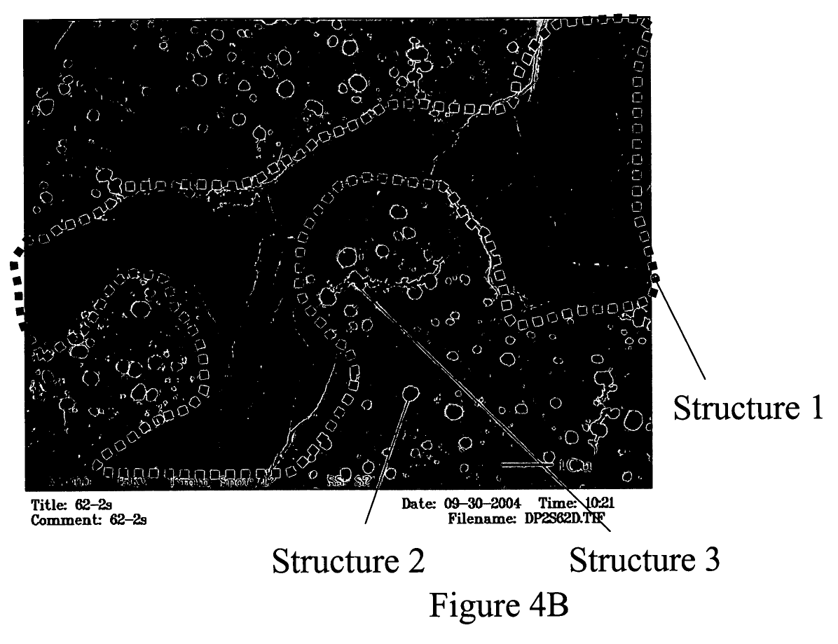

Starch slurries were prepared by jet cooking 700 g of waxy cornstarch in 3500 ml of water 140° C. and at 40 psig at a rate of 1 liter/minute in a Penick and Ford Laboratory Model Steam Jet Cooker. An HC containing waxy starch was prepared as described in Example 1 and used to coat a polyethylene substrate. Dried samples were sputter coated with gold-palladium and were examined and plotographed with SEM. Scanning electron micoscopy examination was performed with a Jeol 6400V electron microscope at a beam voltage of 15KV. Micrographs were recorded following the application of two layers of the HC, FIG. 4A. FIG. 4B is the SEM shown in FIG. 4A with annotation. The SEMs show the surface morphology of the polyethylene plastic coated with 2 layers of the SAC to be essentially uniform having high areas of homogeneity, as shown in FIG. 4B Structure 1 (outlined), with the appearance of micropores, as shown in FIG. 4B Structure 2, and cracks, as shown in FIG. 4B Structure 3. The micropores may be due to air bubbles formed during coating, and cracks may be caused by localized heating during examination of surfaces by SEM.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A hydrophilic coating composition comprising: a hydrophilic base material, an adhesion promoter and a surfactant.

2. The composition of claim 1 wherein the hydrophilic base material is a water-soluble polymer, a water-dispersible polymer, a water-reducible polymer or combinations thereof.

3. The composition of claim 2 wherein the water-soluble polymer is a starch, a starch mixture, a modified starch, a gum, polyvinyl pyrrolidone, modified cellulose, polyvinyl alcohol, polyacrylic acid, polyethyleneimine or combinations thereof.

4. The composition of claim 3 wherein the starch, starch mixture or modified starch is nongelling.

5. The composition of claim 4 wherein the nongelling starch contains less than about 12% amylose.

6. The composition of claim 4 wherein the nongelling starch comprises from about 4 to about 6% of the total solids content of the hydrophilic coating.

7. The composition of claim 1 wherein the hydrophilic base material is a gelling starch.

8. The composition of claim 7 wherein the gelling starch is inhibited from gel formation by mechanical agitation or rapid cooling.

9. The composition of claim 1 wherein the adhesion promoter is an epoxy resin.

10. The composition of claim 1 wherein the surfactant is a fluorosurfactant.

11. The composition of claim 1 wherein the surfactant is sodium lauryl sulfate.

12. The composition of claim 1 further comprising a plasticizer, an emulsifer or both.

13. The composition of claim 1 further comprising a wax emulsion

14. The composition of claim 1 having an adhesion of from about 4 to about 5 as determined in accordance with ASTM D 3359-02, the Tape Test Method.

15. A method of applying a hydrophilic coating to a hydrophobic surface comprising: preparing a hydrophilic coating, heating the hydrophilic coating and spraying the hydrophilic coating on the hydrophobic surface.

16. The method of claim 15 wherein the hydrophilic coating is sprayed using a pneumatic sprayer.

17. The method of claim 15 further comprising simultaneously heating and spraying the hydrophilic coating onto the hydrophobic substrate.

18. The method of claim 15 wherein the hydrophilic coating comprises a water-soluble polymer, an adhesion promoter and a surfactant.

19. The method of claim 18 further comprising a plasticizer, an emulsifier or both.

20. The method of claim 18 wherein the water-soluble polymer is a nongelling starch, a gelling starch, starch mixture, a modified starch or combinations thereof.

21. The method of claim 15 wherein the hydrophobic surface comprises a nonpolar homopolymer, copolymer, polymer blend or combinations thereof.

22. A method of preparing a hydrophilic coating comprising: preparing a solution of hydrophilic base material, heating the solution of hydrophilic base material and mixing at least a portion of the heated hydrophilic base material solution with an adhesion promoter and a surfactant.
